(19) United States
(12) Patent Application Publication
(10) Pub. No.: US 2009/0024502 A1
(43) Pub. Date: Jan. 22, 2009

(54) Application Method of Online Charging System in Arrears Risk Control System

(75) Inventors: LIANG XIE, Nanjing (CN); ZHIQIANG SHAN, Nanjing (CN)

Correspondence Address: GLOBAL IP SERVICES, 7285 W. Eagle Court, Winton, CA, 95388, US

(73) Assignee: NANJING LIANCHUANG SCIENCE & TECHNOLOGY INC., LTD., Nanjing (CN)

(21) Appl. No.: 12/054,659

(22) Filed: Mar. 25, 2008

(30) Foreign Application Priority Data
Jul. 20, 2007 (CN) 200710025310.9

(51) Int. Cl. G06Q 40/00

(52) U.S. Cl. 705/35

(57) ABSTRACT

An application method of On-line Charging System in Arrears Risk Control System: 1) The subsystem of OCS, Mediation, communicates with CC Client, receives a credit control request raised by the CC Client and processes with a fault-tolerant management. 2) The Credit Control analyses call request, identifies a type of service and request, selects necessary service transaction logic, and judges an authorized quota of the service, after receiving the quota, the Credit Control requests for real time forward modeling from the Rating. 3) After receiving a price of the service, the Credit Control requests real time inversion from the Rating and meanwhile transfers the price to the Rating. 4) The Rating requests account comparison from the Account after receiving the price. 5) The Account compares the price with a customer's account information to make decision of subsistence lock, if there is enough balance in the account, then the fee of the price will be deducted from the balance and then locked. 6) The Account returns the account information of the compared result. 7) The Rating inverses the authorization amount according to the compared result returned by the Account, and send back to the Credit Control. 8) The Credit Control constructs a service relevant responding package according to the authorization amount, and sends the responding package to the Mediation to complete the OCS processing flow.

### CROSS REFERENCE TO RELATED PATENT APPLICATION

This application claims the Priority of the Chinese patent application No. 200710025310.9 filed on Jul. 20, 2007, which application is incorporated herein by reference.

### FIELD OF THE INVENTION

This invention is relevant with the arrears risk control method in telecoms billing

### BACKGROUND OF THE INVENTION

In recent years, the mobile telecoms industry has a rapid growth in China. Along with the increase of the income, the carriers is facing more and more serious problem in arrears. Although the technology of intelligent network has relaxed the risk of voice service arrears for some time, several years later, intelligent network has slow customer growth because of long cycle high cost of alternation, inflexible rating, and being unable to transfer network with same phone number. Some provincial branches move all the intelligent customers to offline charging systems. The offline charging system has large-scale integrated reconstruction, which lead to rapid growth of customer numbers. Because of the large cardinal number of customers, carriers still has outstanding revenue leakage, especially in:
1) The risk of arrears is increasing along with the development of new service
2) The spare resource of intelligent network numbers cannot be recycled and unified effectively
3) The colorful data and value added services of 3G introduce the third party partners, which produce the information fee and lead to more outstanding arrears

In order to settle the arrears problem thoroughly, it is necessary to consider the whole credit control. The Online-Charging System (OCS) production solution discussed in this document inherits the requirement of 3GPP specification. It can be adopted to control the arrears risk according to the detailed situation of internal mobile carriers. The main idea of this system is as below:

Operation supporting system cooperates with the core network. The work will be effectively divided the work between each other. The core network will in charge of the functions of control and connection, while the operation supporting system will complete the overall supporting of the services (billing, accounting, authorizing, etc.)

According to the above consideration, telecom carriers home and abroad are also making experiments in this area, like Vodafone, Bouygtel, Colombia Mov, and the intelligent network gateway solution of China mobile

### SUMMARY OF THE INVENTION

The objectives of this invention: provide an application method of online charging system in arrears risk control system; support the development of operating support system from IT supporting system to telecoms level system, from offline charging technology to online charge. In order to solve the arrears problem thoroughly, it is necessary to consider whole credit control. Thus pre-payment and post-payment should be constructed on real charging.

The objective of this invention is also: the effective cooperation and work division between operating support system and core network. The core network will in charge of the functions of control and connection, while the operation supporting system will complete the overall supporting of the services (billing, accounting, authorizing, etc.)

The technical solution of this invention is:

The application method of On-line Charging System in Arrears Risk Control System. The On-line Charging System consists of four core subsystems (Mediation, Credit Control, Rating, and Account) and two assistant subsystems (Monitor Control and Hot Billing).

The stages include:
1) The subsystem of OCS, Mediation, communicates with CC Client (Credit Control Client, like SCP, GGSN). It receives the credit control request raised by CC Client and processes with fault-tolerant management; it will standardize the request into system internal standard request according to different providers, protocols, and network units; and it will forward request to CC client as Agent when there is roaming or non-local services.
2) Credit Control analyses the call request, identify the type of service and request, select necessary service transaction logic, and judge the authorized quota of the service. After receiving the quota, Credit Control requests for real time forward modeling from Rating.
3) After receiving the price of the service, Credit Control request real time inversion from Rating and meanwhile transfer the price to Rating.
4) Rating requests account comparison from Account after receiving the price.
5) Account compares the price with the customer's account information to make decision of subsistence lock. If there is enough balance in the account, then this fee will be deducted from the balance and then locked. If there is exception of the credit control flow (CC Client does not send service close request after raising the request of credit control), system will automatically recycle the amount locked overdue.
6) Account returns the account information to compare the result.
7) Rating inverses the authorization amount according to the result returned by Account, and send back to Credit Control.
8) Credit Control constructs the service relevant responding package according to the authorization amount, and sends it to Mediation to complete the OCS processing flow.

In above stages, the assistant subsystem Monitor Control is in charge of monitoring and reporting the resources occupied by the process (memory, CPU, IO occupation) and the exception situation. It sends alert when the system is overloaded; notified the communication process of host and backup computer to shift; controls the system status: running, backup, stopped, free, etc. It sends out the change order to each functional model when the status needed to be changed; it processes synchronization control through synchronization lock when multi processes are dealing with one data; it backups the transaction result of main application to backup application and disaster recovery system; it outputs list, bill statement, intercepts and identify overdue locked amount and notify the main application for relevant transaction.

When there is exception of the credit control interface between CC Client and OCS, it is necessary to process deduction with following stages:
1) CC Client (SCP) passes and save the calling record (CDR) according to the calling request
2) CC Client (SCP) transfer the bills to assistant subsystem Hot Billing
3) Hot_Billing calculates the relevant charging statement after pretreatment, duplication detection, rating, and account combination.
4) Hot_Billing processes post deduction of customer's balance according to the bill

The real time voice service credit control system is implemented by the coordination among MSC/SSP, SCP, and OCS. It is developed to provide real time control of the calling according to the customers' and accounts information. When there is not enough balance, the system will pause the call to avoid arrears. Its steps include:
(1) Customer is the calling side or called side. Since the CSI has already been added on HLR, MSC/SSP can achieve CSI information. MSC/SSP calls the SCP according to CSI spring to request the control of call from SCP. CSI identifies the SCP information and service key. MSC/SSP reports the call information (like calling and called number) to SCP through IDP message.
(2) SCP reports the call information to OCS, OCS analysis the call information to decide whether or not to permit this calling, and reply the monitor duration to SCP.
(3) SCP sends out RRBE message to ask MSC/SSP to monitor call event
(4) SCP sends out AC message, which include the duration of OCS answer. If OCS previously setups the allowing id, it will also be included in this AC.
(5) SCP sends out Continue/Connect message, and MSC/SSP goes on with the following connection. SCP monitors the calling. If OCS does not use partition control technology, then OCS will send the whole duration to SCP, SCP will be in charge of the partition control, and jump to step 8; If OCS uses the partition control technology, then SCP will request one more time partition from OCS after it uses out the last one and it can choose step 6 and 7. It might have multiple interactions.
(6) MSC/SSP send ACR request to SCP when the call duration set by AC comes to the end. SCP reports relevant information about this call to OCS, and request OCS to calculate the actual available call duration.
(7) OCS calculates out the available call duration according to customer information and account information, and then send it to SCP
(8) When call ends, MSC/SSP notifies SCP. SCP reports the duration information of this call to OCS. OCS charges this call and updates the virtual account.
   The further transactions of step 2 above are:
1) If the customer does not need monitoring, OCS will notify SCP to not go on with subsequent monitoring and reporting
2) If the customer need monitoring, and this type of call is not allowed to connect, then OCS notifies SCP to pause the call, not go on with subsequent monitoring and reporting
3) If the customer need monitoring, and this type of call is allowed to connect, the OCS notifies SCP to send out subsequent signor to continue with the call
4) If the customer needs monitoring, while OCS cannot normally calculate the allowed duration of this call, then OCS returns the default duration and notifies SCP to send out subsequent signor to continue with the call.

The control of short messages by real time credit control function is completed by the short message control flow. The steps include:
(1) When customers send out short messages, it sends shot message request to SMSC
(2) SMSC reports the short message event to SCP
(3) SCP sends the event to OCS for authorization
(4) OCS processes the balance authorization through direct charging authorization method
(5) OCS sends the balance authorization information back to SCP
(6) SCP send authorization id to SMSC according to balance authorization information
(7) Short message center sends the short message to end customer after passing the balance authorization
(8) If the short message sending fails, short message center will retry multi-times
(9) If overtime, short message center sends the short message sending failure status report to SCP (optional)
(10) SCP forwards the short message sending failure status to OCS (optional)
(11) OCS launches or not launches fee return according to requirements
   The core functions of Online Charging System (OCS) are real time charging and real time credit control. So Online Charging System (OCS) can be used in arrears risk control.

Its functional structure is as follow:

Online Charging System consists of four core subsystems (Mediation, Credit Control, Rating, and Account) and two integrant assistant subsystems (Monitor Control, and Hot_Billing)

### Mediation:

Communicate with CC Client (Credit Control Client, like SCP, GGSN). It receives the credit control request raised by CC Client and processes
fault-tolerant management; it will standardize the request into system internal standard request according to different providers, protocols, and network units
Forward request to CC client as Agent when there is roaming or non-local services.

Credit Control:
Credit Control analyses the call request, identify the type of service and request, select necessary service transaction logic, judge the authorized quota of the service, and requests for real time inversion and real time rating from Rating Server. It then request account subsistence or payment according to the result of inversion, and responds the authorization result according to the respond result of Account.
When there is exception of credit control flow (CC Client does not send out service ending request after launch the credit control request), system will automatically recycle overdue locked quota

Rating:
Accept the real time inversion request from Credit Control, and calculate the quota can be authorized according to the account balance
Accept the real time rating request from Credit Control, and calculate the fee according to the quota used and applied
Support account combination to support consume history related tariff plan, and be provided to Account for account transaction
When Account does not support the amount, Rating will exchange the amount to identifiable account type for Account

Account:
Standard account transaction, like life cycle management, topping-up, account favorable, account transfer, account enquiry
Provide real time account keeping and account payment functions for online charging

Monitor Control:
Be in charge of monitoring and reporting the resources occupied by the process (memory, CPU, IO occupation) and the exception situation.
Send alert when the system is overloaded; notified the communication process of host and backup computer to shift; controls the system status: running, backup, stopped, free, etc.
Send out the change order to each functional model when the status needed to be changed; it processes synchronization control through synchronization lock when multi processes are dealing with one data;
Backup the transaction result of main application to backup application and disaster recovery system;
Output list, bill statement,
Intercept and identify overdue locked amount and notify the main application for relevant transaction.

Hot_Billing:
When there is exception of the credit control interface between CC Client and OCS, in order to not influence user satisfaction, CC Client can authorize call request and save the call record (CDR). At this time, Online Charging System will adopt Hot-Billing offline charging method.

When using OCS in actual commercial environment, functional modules and groupware can be flexibly added, deducted or provided by third parties according to carriers' request. For instance, add AAA Server, or providing Rating Server or Account Server by the third party.

### Applicable Scope:

OCS method has wide applicable scope:
Cooperate with SCP to complete the real time charging and real time credit control of voice service
Cooperate with GGSN to complete the real time charging and real time control of data services in group to implement the arrears control at the network layer. Selecting GGSN is compliable to the development of 3GPP standard. It can be combined with content billing to provide real time content charging
Cooperate with service platform and service gateway (like DSMP, LCS), to complete the real time charging and real time credit control of the data service and value added service
This product is applicable to variable network, including but not limited on GSM, GPRS, CDMA, UMTS, PSTN, WLAN, etc.

### System Requirement:

Real Time Ability of Charging:
It is usually using file interface method among original BOSS charging processes. By using the communication mechanism among processes, OCS is using the shared memory or message interface to avoid the delay by the hard disk. It can increase the processing ability and equilibrium of the service requested transaction time by multi-channel, multi-process, multi-thread.

System Stableness
OCS adopts hot backup technology, which can regularly synchronize the data and status of main application to backup application. When there is exception of main application, backup application with automatically take the role.

System Expandability:
1. Online upgrading: OCS adopts the multi-process mechanism. When system needs upgrade, it only need to use the upgraded processes to take the place of the original process. It has low upgrade risk, and has no influence of system transaction.
2. Service irrelevant: The core Credit Control model abstracts unified and standard transaction logic from different services to fully make it irrelevant with services and protocols. Thus no matter how the services change in the future, it will have low influence to the system.

### Beneficial Effect:

The OCS product can bring following benefits to carriers:

1: Solve the arrears problem: Wholly real time credit control and charging to effectively control the arrears risks.

2: More Flexible and Accurate Charging

By online charging technology, it can more conveniently provide real time support of intersectional favorable price among multi-services (for instance when the consumption of service A reach amount N, system can give M amount of service B free) to help sales promotion of new services (which is more meaningful in 3G). It greatly reduces the investment and implementation of new services.

3: Provide AoC

By using OCS, it can provide real time advice of charging for customers. The advices include price of the service requested, account balance enough or not to support this service, and current consumption, etc.

4: Arrears Control to Post-Payment

OCS is not only applicable to pre-paid customers, but also to post-paid customers who have outstanding arrears problem. It can be used to control the quota of the arrears.

5: Implement Integrated Charging

Based on the OCS plan, it will be easy to implement integrated charging. By integrated charging, carriers can:
Provide unified customer information module and account information module
Provide unified production list
Provide unified pricing system to implement the flexibility of pricing
Unified management to lower down the cost, and provide rapid and unified service support to customers of all networks
Implement the final objective of “transfer service with same number”
   Currently this system has already been implemented by Jiangsu Mobile, and has been running till now. The system situation of Jiangsu Mobile will be introduced below:
   2 IBM P590 Mainframe, 10 CPU, 40 G Memory, 4x72 G inner hard disks
   2 IBM P595 Mainframe, 22 1.9 G CPU, 69 G Memory, 4x73 G inner hard disk

ChangZhou City Branch—200606 Statistic Data

Duration of Connection
Relevant customer connection duration has come increase
Increased connection duration is relevant with the performance of SCP
After online testing analysis, current connection duration is about 8 to 10 seconds, with no obvious delay to the customer connection. This figure is greatly decreased after the upgrade of SCP, basically controlled within 5 seconds

Control Effects
Effective control in baleful arrears
60% to 70% customers are monitored
Average amount of arrears of monitored customers is within 2 Yuan; this figure of normal customer is around 8 Yuan
160 thousand of customer losing every month
arrears of voice service can be deducted by 160×60%×(8−2)=576 (thousand) Yuan for one month, and 6.912 million Yuan for one year

### BRIEF DESCRIPTION OF THE DRAWINGS

FIG. 1: Control Flow of the invention.

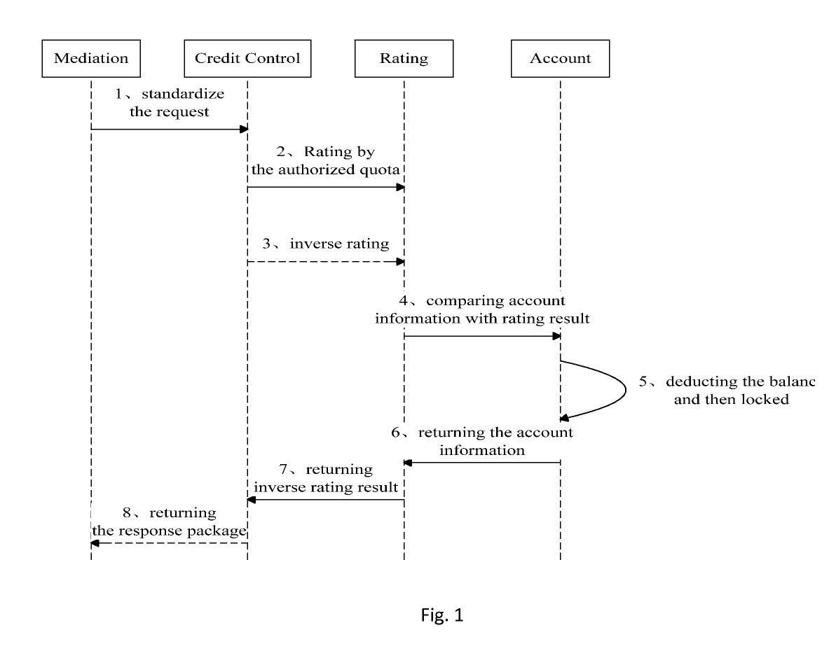

FIG. 2: Control Flow of when there is exception of the credit control interface between CC Client and OCS, it is necessary to process deduction with stages.

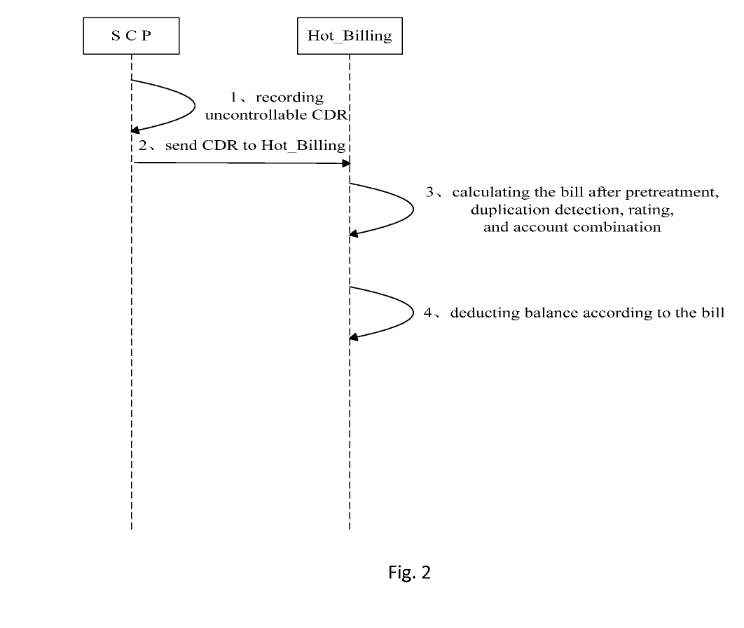

FIG. 3: OCS System Functional Structure

FIG. 4 is Methods of Network Structure

FIG. 5 is Voice control Flow

FIG. 6 is Control Flow of Short Messages

### DETAIL DESCRIPTION OF THE INVENTION

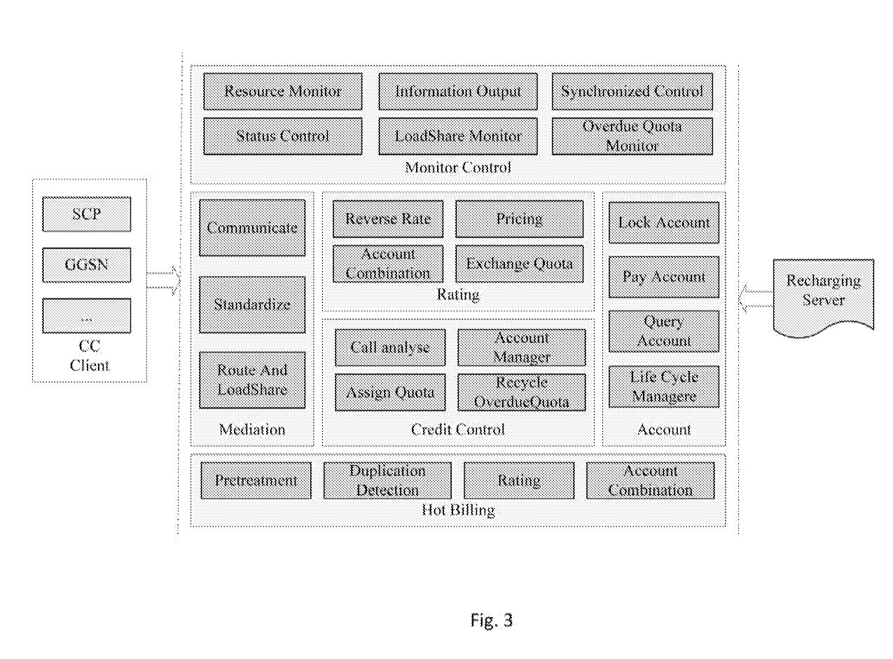

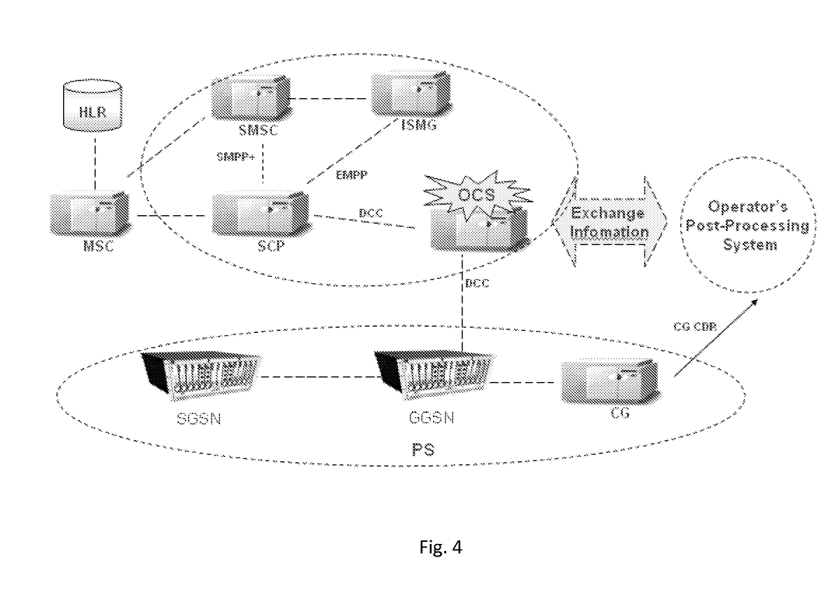

FIG. 3 and FIG. 4 above mainly list out the position of OCS system in current GSM/GPRS networks:

Network construction between OCS and other network units
a) DIAMETER CC protocol is adopted between OCS and SCP, based on TCP/IP
b) DIAMETER CC protocol is adopted between OCS and GGSN, which is used to control the GPRS service in the future
c) BOSS will control customer list, customer information and account information. It will be synchronized with OCS by files

Two typical services will be described below to explain the process flow

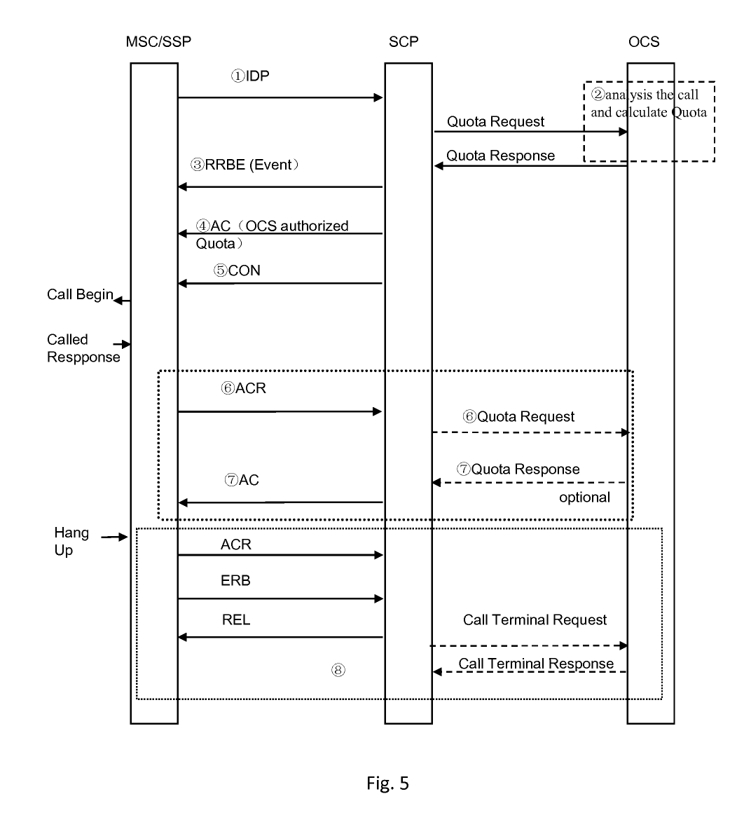

1. Voice Control Flow (Call Type shown in FIG. 5)

The real time voice service credit control system is implemented by the coordination among MSC/SSP, SCP, and OCS. It is developed to provide real time control of the calling according to the customers' and accounts information. When there is not enough balance, the system will pause the call to avoid arrears.
(1) Customer is the calling side or called side. Since the CSI has already been added on HLR, MSC/SSP can achieve CSI information. MSC/SSP calls the SCP according to CSI spring to request the control of call from SCP. CSI identifies the SCP information and service key. MSC/SSP reports the call information (like calling and called number) to SCP through IDP message.
(2) SCP reports the call information to OCS, OCS analysis the call information to decide whether or not to permit this calling, and reply the monitor duration to SCP.
   a) If the customer does not need monitoring, OCS will notify SCP to not go on with subsequent monitoring and reporting
   b) If the customer need monitoring, and this type of call is not allowed to connect, then OCS notifies SCP to pause the call, not go on with subsequent monitoring and reporting
   c) If the customer need monitoring, and this type of call is allowed to connect, the OCS notifies SCP to send out subsequent signor to continue with the call
   d) If the customer need monitoring, while OCS cannot normally calculate the allowed duration of this call, then OCS returns the default duration and notifies SCP to send out subsequent signor to continue with the call
(3) SCP sends out RRBE message to ask MSC/SSP to monitor call event
(4) SCP sends out AC message, which include the duration of OCS answer. If OCS previously setups the allowing id, it will also be included in this AC.
(5) SCP sends out Continue/Connect message, and MSC/SSP goes on with the following connection. SCP monitors the calling. If OCS does not use partition control technology, then OCS will send the whole duration to SCP, SCP will be in charge of the partition control, and jump to step 8; If OCS uses the partition control technology, then SCP will request one more time partition from OCS after it uses out the last one and it can choose step 6 and 7. It might have multiple interactions.
(6) MSC/SSP send ACR request to SCP when the call duration set by AC comes to the end. SCP reports relevant information about this call to OCS, and request OCS to calculate the actual available call duration.
(7) OCS calculates out the available call duration according to customer information and account information, and then send it to SCP
When call ends, MSC/SSP notifies SCP. SCP reports the duration information of this call to OCS. OCS charges this call and updates the virtual account.

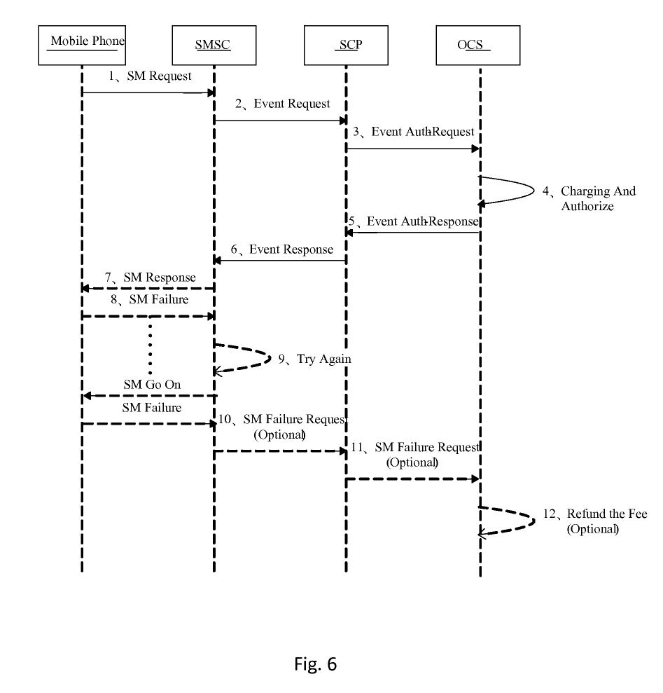

2. Control Flow of Short Messages (Event Type shown in FIG. 6)

When customers send out short messages, it sends shot message request to SMSC
(1) SMSC reports the short message event to SCP
(2) SCP sends the event to OCS for authorization
(3) OCS processes the balance authorization through direct charging authorization method
(4) OCS sends the balance authorization information back to SCP
(5) SCP send authorization id to SMSC according to balance authorization information
(6) Short message center sends the short message to end customer after passing the balance authorization
(7) If the short message sending fails, short message center will retry multi-times
(8) If overtime, short message center sends the short message sending failure status report to SCP (optional)
(9) SCP forwards the short message sending failure status to OCS (optional)
   OCS launches or not launches fee return according to requirements

What is claimed is:

1. An application method of On-line Charging System in Arrears Risk Control System comprising:
The On-line Charging System (OCS) including four core subsystems (Mediation, Credit Control, Rating, and Account) and two assistant subsystems (Monitor Control and Hot Billing) provides real time billing and credit control functions through following steps:
1) the subsystem of OCS, Mediation, communicates with CC Client (Credit Control Client, like SCP, GGSN), receives a credit control request raised by the CC Client and processes with a fault-tolerant management; the subsystem of OCS will standardize requests into system internal standard requests according to different providers, protocols, and network units and will forward requests to the CC client as Agent when there is roaming or non-local services;
2) the Credit Control analyses call requests, identifies a type of service and request, selects necessary service transaction logic, and judges an authorized quota of the service, after receiving the quota, the Credit Control requests for real time forward modeling from the Rating;
3) After receiving a price of the service, the Credit Control requests real time inversion from the Rating and meanwhile transfers the price to the Rating;
4) the Rating requests account comparison from the Account after receiving the price;
5) the Account compares the price with a customer's account information to make decision of subsistence lock, if there is enough balance in the account, then the fee of the price will be deducted from the balance and then locked, if there is exception of the credit control flow (the CC Client does not send service close request after raising the request of credit control), the OCS system will automatically recycle the amount locked overdue.
6) The Account returns the account information of the compared result.
7) The Rating inverses the authorization amount according to the compared result returned by the Account, and send back to the Credit Control.
8) The Credit Control constructs a service relevant responding package according to the authorization amount, and sends the responding package to the Mediation to complete the OCS processing flow.
In the above-mentioned stages, the assistant subsystem Monitor Control is in charge of monitoring and reporting resources occupied by the process (memory, CPU, IO occupation) and the exception situation; sends alert when the system is overloaded, notified a communication process of host and backup computer to shift; controls the system status: running, backup, stopped, free, etc, sends out a change order to each functional model when status needed to be changed; processes synchronization control through synchronization lock when multi processes are dealing with one data; backups the transaction result of main application to backup application and disaster recovery system; outputs list, bill statement, intercepts and identify overdue locked amount and notify the main application for relevant transaction;
When there is exception of the credit control interface between the CC Client and the OCS, it is necessary to process deduction with following stages:
1) the CC Client (SCP) passes and save a calling record (CDR) according to a calling request,
2) the CC Client (SCP) transfers bills to the assistant subsystem Hot Billing,
3) the Hot_Billing calculates the relevant charging statement after pretreatment, duplication detection, rating, and account combination,
4) The Hot_Billing processes post deduction of customer's balance according to the bill.

2. The application method of Online Charging System in Arrears Risk Control System of claim 1, wherein a real time voice service credit control system is implemented by the coordination among MSC/SSP, SCP, and OCS to provide real time control of a calling according to the customers' and accounts information, when there is not enough balance, the system will stop the call to avoid arrears, its steps include:
(1) the customer is the calling side or called side, since the CSI which has already been added on HLR, MSC/SSP can achieve the CSI information, the MSC/SSP calls the SCP according to the CSI spring to request a control of call from the SCP, The CSI identifies the SCP information and service key, the MSC/SSP reports the call information (like calling and called number) to the SCP through IDP message.
(2) The SCP reports call information to the OCS, the OCS analysis the call information to decide whether or not to permit this calling, and reply a monitor duration to the SCP.
(3) the SCP sends out RRBE message to ask the MSC/SSP to monitor call event
(4) The SCP sends out AC message, which include the duration of OCS answer, if the OCS previously setups an allowing id, it will also be included in this AC.
(5) the SCP sends out Continue/Connect message, and the MSC/SSP goes on with the following connection, the SCP monitors a calling, if the OCS does not use partition control technology, then the OCS will send a whole duration to the SCP, the SCP will be in charge of the partition control, and jump to step 8; if the OCS uses the partition control technology, then the SCP will request one more time partition from the OCS after it uses out the last one and it can choose step 6 and 7, the SCP might have multiple interactions.
(6) The MSC/SSP send ACR request to the SCP when the call duration set by the AC comes to the end, the SCP reports relevant information about this call to the OCS, and request the OCS to calculate the actual available call duration.
(7) the OCS calculates out an available call duration according to the customer information and account information, and then send it to the SCP
(8) When call ends, the MSC/SSP notifies the SCP, The SCP reports the duration information of this call to the OCS, the OCS charges this call and updates a virtual account.

3. The application method of Online Charging System in Arrears Risk Control System of claim 2, wherein in the step 2:
1) If the customer does not need monitoring, the OCS will notify the SCP without going on with subsequent monitoring and reporting
2) If the customer needs monitoring, and this type of call is not allowed to connect, then the OCS notifies the SCP to pause the call, not to go on with subsequent monitoring and reporting
3) If the customer needs monitoring, and this type of call is allowed to connect, the OCS notifies the SCP to send out subsequent signor to continue with the call
4) If the customer needs monitoring, while the OCS cannot normally calculate the allowed duration of this call, then the OCS returns the default duration and notifies the SCP to send out subsequent signor to continue with the call

4. The application method of Online Charging System in Arrears Risk Control System of claim 1, wherein a control of short messages by real time credit control function is completed by a short message control flow including the following steps:
(1) When customers send out short messages the customers send shot message request to a SMSC,
(2) the SMSC reports the short message event to the SCP,
(3) the SCP sends the event to the OCS for authorization,
(4) the OCS processes a balance authorization through direct charging authorization method,
(5) the OCS sends the balance authorization information back to the SCP
(6) the SCP send an authorization id to the SMSC according to the balance authorization information
(7) the Short message center sends the short message to an end customer after passing the balance authorization
(8) If the short message sending fails, the short message center will retry multi-times
(9) If overtime, the short message center sends the short message sending a failure status report to the SCP (optional)
(10) the SCP forwards the short message sending failure status to the OCS (optional)
(11) the OCS launches or not launches fee return according to requirements
